(19) United States
(12) Patent Application Publication
(10) Pub. No.: US 2012/0321733 A1
(43) Pub. Date: Dec. 20, 2012

(54) COEXTRUSION ADAPTER

(75) Inventors: Bianca Lauwers, Sankt Augustin (DE); Achim Kaun, Neunkirchen (DE); Helmut Meyer, Troisdorf (DE)

(73) Assignee: Reifenhaeuser GmbH & Co. KG Maschinenfabrik, Troisdorf (DE)

(21) Appl. No.: 13/514,253

(22) PCT Filed: Dec. 9, 2010
(86) PCT No.: PCT/EP10/07492

§ 371 Date: Aug. 20, 2012

(30) Foreign Application Priority Data
Dec. 10, 2009 (EP) 09015280.2

(51) Int. Cl. B29C 47/06

(52) U.S. Cl. 425/113

(57) ABSTRACT

A device for producing multi-layer composites made of thermoplastic materials, including a coextrusion adapter through which the thermoplastic materials can flow. The adapter has an inlet opening and an outlet opening, in which the thermoplastic materials are combined in layers. The coextrusion adapter has a modular design including a plurality of housings stacked on top of each other in a modular manner, each having a central channel arranged in the housing and at least one coextrusion channel opening into the respective central channel. The central channels of the housings stacked on top of each other continue one another, and the thermoplastic materials can flow through the central channel and the coextrusion channels in the direction of the outlet opening. Each housing further includes a receiving bore that extends through the central channel and into which a coextrusion pin can be inserted, which in turn has a channel bore that continues the central channel and in some regions forms a partial section of the at least one coextrusion channel between the outer surface and the wall of the receiving bore.

### BACKGROUND OF THE INVENTION

1. Field of the Invention

This invention relates to a device for producing multi-layer composites of thermoplastic materials, including a coextrusion adapter and an outlet opening, in which adapter the thermoplastic materials are combined in layers.

2. Discussion of Related Art

Known devices are used for combining a plurality of thermoplastic materials, which usually also originate in a corresponding plurality of extruders, for example in the context of producing films, plates, and panels. The individual thermoplastic materials, in the form of thermoplastic melts, are in the coextrusion adapter on one another in the desired layer position and then delivered to an extrusion tool for producing the multi-layer composite. The thermoplastic material flowing into the central channel forms at least one inner layer, and the thermoplastic materials delivered via the coextrusion channels are disposed externally.

Examples of such coextrusion adapters are the subject of German patent disclosures DE-OA 37 41 793 and DE 197 57 827 A1 and European patent disclosure EP 1 621 320 A1. The coextrusion adapters described there are distinguished because the layer distribution can be varied from outside during the operation of the system. The adjustment is made via multi-part adjusting elements. This is absolutely necessary for attaining very high-quality products, but it dictates a coextrusion adapter that is very laborious to make and thus is expensive.

A structurally simpler coextrusion adapter is the subject of U.S. Pat. No. 3,743,460 A.

From Japanese patent disclosure JP 61 241 121 A, a device is known in which a coextrusion adapter is provided that has a housing with a central channel and that has coextrusion channels that discharge into the coextrusion channel. The central channel has a receiving bore penetrating it, into which receiving bore a coextrusion pin can be inserted, which in turn has a channel bore that continues a central channel and that in some regions, between its outer surface and the wall of the receiving bore, forms a portion of the at least one coextrusion channel. With such a coextrusion adapter, three-layer composites can be produced. If the number of layers is increased, for example to five layers, then the housing of the coextrusion adapter is correspondingly made larger, so that two successive receiving bores, for instance, for coextrusion pins can be disposed in the central channel. One disadvantage of such coextrusion adapters is that they are fixed for the particular number of layers to be combined in the coextrusion adapter, and changes in the number of layers either cannot be made or can be made only at great expense. This makes the known device inflexible and expensive.

### SUMMARY OF THE INVENTION

It is one object of the invention to provide a device which by comparison can be produced more economically, can be adapted flexibly and quickly to different production conditions, and makes high product quality possible.

For attaining this object according to the invention the embodiment defined by the features of this specification and the claims.

Advantageous embodiments and refinements of the invention are the subject of this specification and the claims.

Within the scope of this invention, the coextrusion adapter can be provided with a construction of housings stacked on one another in modular fashion, each with a central channel disposed in the housing, and with at least one coextrusion channel discharging into the respective coextrusion channel. The central channels of the housings stacked modularly on one another continue one another, and the thermoplastic materials can flow through the central channel and the coextrusion channels in the direction of the outlet opening, and each housing further has a receiving bore, which penetrates the central channel and into which a coextrusion pin can be inserted, which coextrusion pin in turn has a channel bore penetrating the central channel and which in some regions, between its outer surface and the wall of the receiving bore, forms a portion of the at least one coextrusion channel.

With a suitable choice of the number of housings stacked in modular fashion on one another, the central channels of which housings continue one another, it is possible for the number of thermoplastic materials that can be combined in layers in the device to be varied arbitrarily. If the desired number of layers exceeds the maximum number of layers in one housing, a further housing is joined in modular fashion to the preceding housing, and as a result the number of layers increases accordingly. Thus with one housing, up to three layers can be joined to one another. With two housings, up to five, with three housings up to seven, and with four housings up to nine layers can be joined, and this number can be increased still further by suitable numbers of further housings stacked in modular fashion on one another. In the same way, the maximum number of layers that can be processed by an existing coextrusion adapter can also be reduced, by removing individual housings. Because of the broad matching of the modular housings, the manufacturing and storage costs are low, and production changes can be achieved with short conversion times and extremely slight losses when changing materials.

According to this invention, the central channel formed in a respective housing can be penetrated preferably transversely by the penetrating receiving bore, but with a coextrusion pin inserted, the central channel is continued by the channel bore of the coextrusion pin, so that between the inlet opening and the outlet opening of the housing, a continuous central channel extending in one portion through the coextrusion pin is embodied, through which thermoplastic material can flow during production of multi-layer composites.

The coextrusion pin can be shaped so that at least in some regions between its outer surface and the wall of the receiving bore, a certain spacing exists, which forms a portion of the at least one coextrusion channel.

In this manner, the thermoplastic material flowing through the central channel and at least in one portion through the channel bore of the coextrusion pin forms at least one middle layer, while the thermoplastic material which is delivered via the coextrusion channel and is carried at least in some regions between the outer surface of the channel bore and the wall of the receiving bore forms at least one outer layer, such as a cover layer, of the multi-layer composite to be produced.

An adaptation of the respective layer thicknesses of the thermoplastic material carried in the central channel and/or in the at least one coextrusion channel to existing production conditions, to the raw materials employed, and to the rheological properties of those materials, can simplify production technology, by variously shaped coextrusion pins, which depending on the particular application can be inserted into the receiving bore of the housings and which are distinguished by different geometries in the region of the channel bore and/or of the outer wall in the region of the portion of the at least one coextrusion channel.

In accordance with one embodiment of this invention, the channel bore in the coextrusion pin and/or the portion of the at least one coextrusion channel that extends between the wall of the receiving bore and the outer surface of the coextrusion pin has a cross section which, viewed in the direction of the outlet opening, varies from a circular to a rectangular shape. Thus, the coextrusion pin also converts the melt of the thermoplastic material, which initially is typically delivered into a channel of round cross section, into a rectangular cross-sectional flow, which is then extruded with such a rectangular cross section from a wide-slit nozzle for producing films, plates, or panels.

The term “circular design” is understood to mean not only an exact circular shape but also similar cross-sectional shapes, such as oval cross-sectional shapes.

In one embodiment of this invention, one coextrusion channel is embodied on each of the two sides of the central channel of each modular housing, so that per housing, three layers can be obtained, namely two outer layers, each via one coextrusion channel, and one inner layer via the central channel.

In a further embodiment of this invention, the at least one coextrusion channel has an adjusting device for the prevailing flow cross section, to make it possible to influence the layer thickness that is formed from the thermoplastic material delivered via the coextrusion channel still further. Such an adjusting device is formed by a pin, which partly penetrates the coextrusion channel and functions as a throttle device and which can be contoured in various ways in its region that penetrates the coextrusion channel. Thus it is possible, by rotating the pin from outside during ongoing operation, to exert a certain influence on the flow cross section and thus on the layer formation which is effected via the coextrusion channel. With a suitably contoured pin, a complete closure of a coextrusion channel can also be effected, to obtain further possibilities of varying the number of layers and their positioning.

As explained above, when the modular housings of the coextrusion adapter is designed with two coextrusion channels, it is possible to embody a three-layer composite. If more than three layers within the composite to be produced are desired, then because of the modular construction according to this invention, a plurality of such housings, with a coextrusion pin inserted into each, are stacked on one another such that the various central channels continue one another. Thus, viewed in the flow direction, in the first housing a composite with a maximum of three layers is first produced, which is then delivered to the central channel in the second housing, so that up to two further layers can be applied to the outside of the previously produced three-layer composite. By corresponding successive addition multiple times, a many-layered melt extrusion with 4, 5, 6, 7, 8, 9, and more layers, for example, can be created, which is then finally delivered to a tool that is connected downstream of the coextrusion adapter.

Thus, the housings that can be stacked on one another in arbitrary suitable numbers have suitable connecting and sealing means on the joining faces that face one another, to enable coupling them in modular fashion to make a coextrusion adapter with the desired number of layers.

For variable layer distribution, in the region of the inlet openings of the central channel and of the at least one coextrusion channel, an adapter plate can be provided for connecting delivery devices for the thermoplastic materials, which devices can be exchanged for one another in order to vary the association of the melts with the individual layers.

### BRIEF DESCRIPTION OF THE DRAWINGS

Further embodiments and details of this invention are described in further detail below in view of exemplary embodiments shown in the drawings, wherein:

FIG. 1 is a vertical section taken through a first embodiment of the device of this invention;

FIG. 2 is a vertical section taken through the first embodiment of the coextrusion adapter of this invention, in a sectional plane rotated by 90° from FIG. 1;

FIG. 3 shows the coextrusion adapter of the first embodiment of this invention in a perspective view;

FIG. 4 is a vertical section taken through a second embodiment of the coextrusion adapter of this invention;

FIG. 5 is a vertical section taken through the second embodiment of the coextrusion adapter of this invention, in a sectional plane rotated by 90° from FIG. 4;

FIG. 6 shows the coextrusion adapter of this invention in the second embodiment in a perspective view;

FIG. 7a is a side view of a pin in one embodiment of this invention;

FIG. 7b shows the section A-A in FIG. 7a; and

FIG. 8 is a side view of a pin in a second embodiment of this invention.

### DETAILED DESCRIPTION OF THE INVENTION

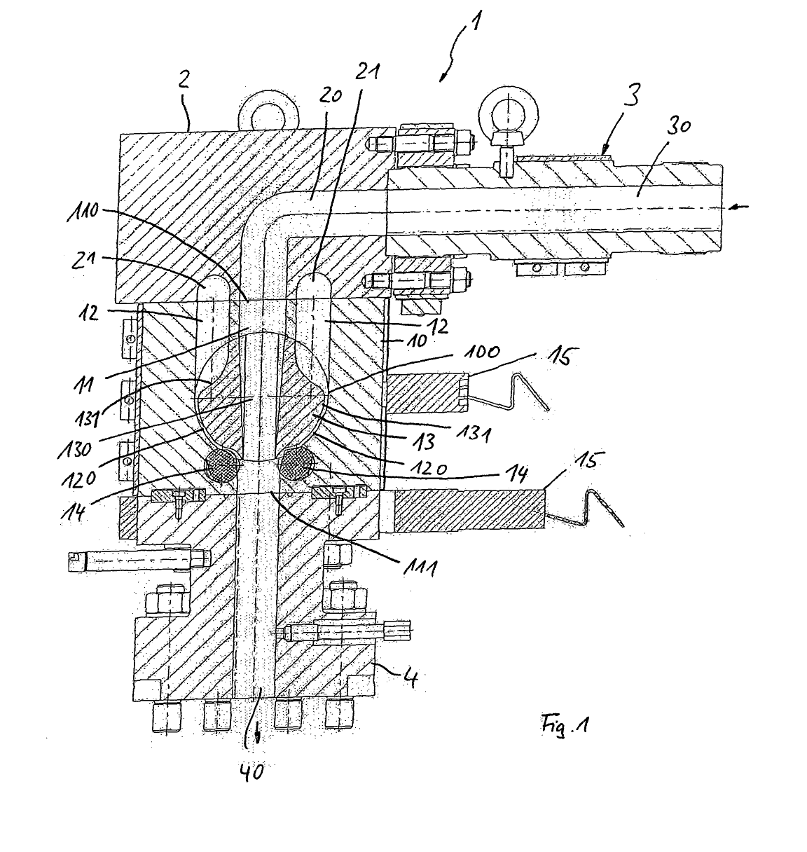

FIGS. 1-3 show a coextrusion adapter can be seen which forms a multi-layer composite of thermoplastic materials in a tool downstream of the coextrusion adapter 1 that is not shown here, such as a wide-slit tool for producing films, plates or panels.

Thus, the coextrusion adapter 1 includes a plurality of melt lines 3, 5, 6, each with respective melt channels 30, 50, 60, through which a given melt of the thermoplastic material is delivered to the coextrusion adapter 1 in the flow direction indicated by arrows from extruders, not shown in detail.

The delivered melts are each diverted, inside an angle connection piece 2 in diversion channels identified by reference numerals 20, 21, from the original delivery direction into a flow direction aimed at a housing 10.1 and then enter the housing identified by reference numeral 10.1, which like the other parts of the coextrusion adapter 1 is tempered via external heaters 15 to a temperature suitable for transporting the thermoplastic melts.

The diversion channel 20 discharges via an inlet opening 110 into a central channel 11, embodied inside the housing 10.1, while the two diversion channels 21 discharge into coextrusion channels 12 that correspondingly continue in the housing 10.1.

Both the central channel 11 and the two coextrusion channels 12 are penetrated by a receiving bore 110 which extends horizontally, such as transversely to the flow direction, in this case, vertically downward, and which extends transversely through the housing 10.1. A coextrusion pin 13 is inserted sealingly into the receiving bore 100 and in turn has a channel bore 130, extending diametrically through the coextrusion pin 13. The channel bore 130 is oriented so that it continues the central channel 11 in the direction of the outlet opening 111 of the central channel and thus forms a portion of the central channel 11.

The design of the channel bore 130 is selected so that its cross section, beginning at the end toward the inlet opening 110, changes toward the end toward the outlet opening 111 from an initially circular design into a rectangular design, and thus a flow of the thermoplastic material entering the central channel 11 via the melt channels 30, 20 is changed from an initially cylindrical billet to a square one, which from there emerges from the central channel 11 via an outlet opening 11 into a downstream tool connection part 4 with a corresponding melt channel 40.

The pin, which has a cylindrical shape outside the region where it penetrates the central channel 11 and the coextrusion channels 12 and thus completely fills the channel bore 130, is contoured and shaped in the vicinity of or near its outer surface 131, in the region of the coextrusion channels 12 penetrated by the receiving bore 100, on both sides of the central channel 11, so that there is a spacing or gap from the wall of the receiving bore 100, so that this gap forms a portion 120 of the coextrusion channels 12 and thus continues the coextrusion channel 12 that is penetrated by the receiving bore 100. In this region as well, the cross-sectional design is selected so that the initially circular cross section of the portion 120 of the at least one coextrusion channel 12 is gradually converted into a rectangular cross section, so that the melt carried in the coextrusion channels 12 undergoes a change in its cross section.

Finally, the portions 120 of the respective coextrusion channels 12 embodied between the outer surface 131 of the channel bore 13 and the wall of the receiving bore 100 discharge into the central channel 11, in fact exactly at the point where the thermoplastic material, carried via the channel bore 130 in the coextrusion pin 13, leaves the channel bore 130 in the direction of the outlet opening 111 of the central channel, so that the thermoplastic materials carried via the portions 120 are applied on both sides to the outside of the thermoplastic material from the channel bore 130. A three-layer composite is thus created, which via the outlet opening 111 passes jointly into the melt channel 40 in the tool connection part 4 and from there is delivered to the tool, not shown here. The thermoplastic material carried in the channel bore 130 forms the inner layer, and the two thermoplastic materials carried in the coextrusion channels 12 and 120 form the cover layer and outer layer, respectively, of the multi-layer composite.

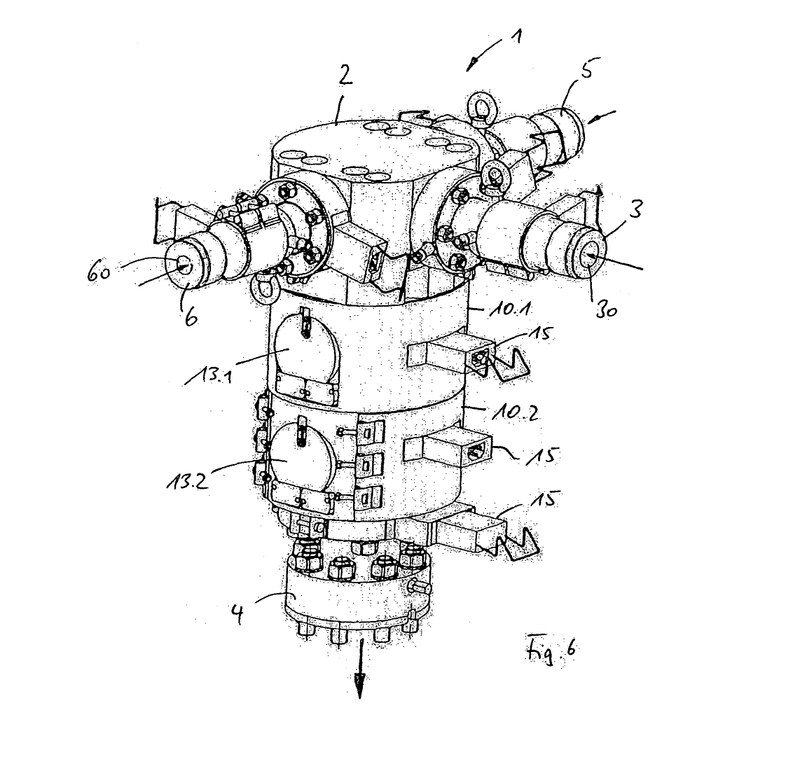

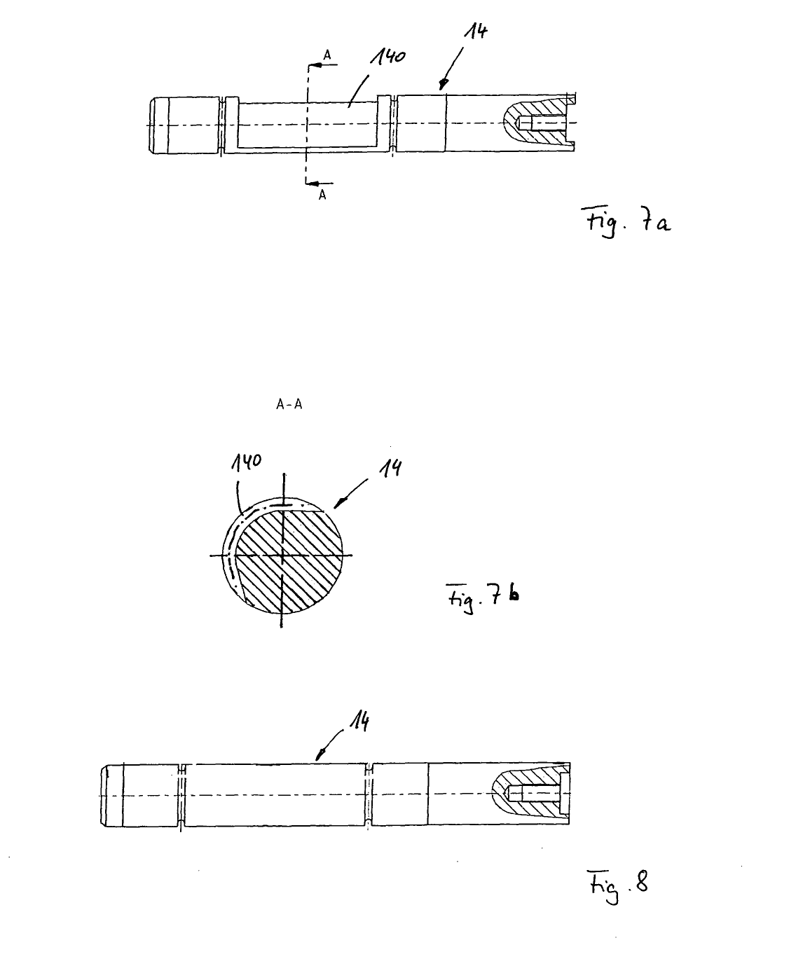

FIG. 1 shows that for varying the flow cross section and thus the thickness profile of the thermoplastic materials delivered via the coextrusion channels 12 and 120, adjusting devices in the form of pins 14 that partly penetrate the coextrusion channel 12 in the portion 120 are formed, which have an outer contour to suit the production job and the rheology of the thermoplastic materials used and which serve as a throttle restriction. They can furthermore be rotated from outside about their own axis, in order to achieve a certain play in terms of the adjustment. FIGS. 7a and 7b show that the essentially cylindrical pin 14 has a recessed region 140 recessed over part of its circumference, by way of which the corresponding thermoplastic material flows over into the coextrusion channel 12. Depending on the rotational position or orientation of the region 140, different flow cross sections are thus obtained.

With a pin 14 shown in FIG. 8 and that can be used instead of the pin 14 of FIGS. 7a and 7b, it is possible to close a coextrusion channel 12 completely, so that the number of layers in the housing 10.1 is reduced accordingly, for instance from three layers to two. Thus, the pin 14 of FIG. 8 has a continuously cylindrical cross section and fills the associated receiving bore in the housing 10.1 completely.

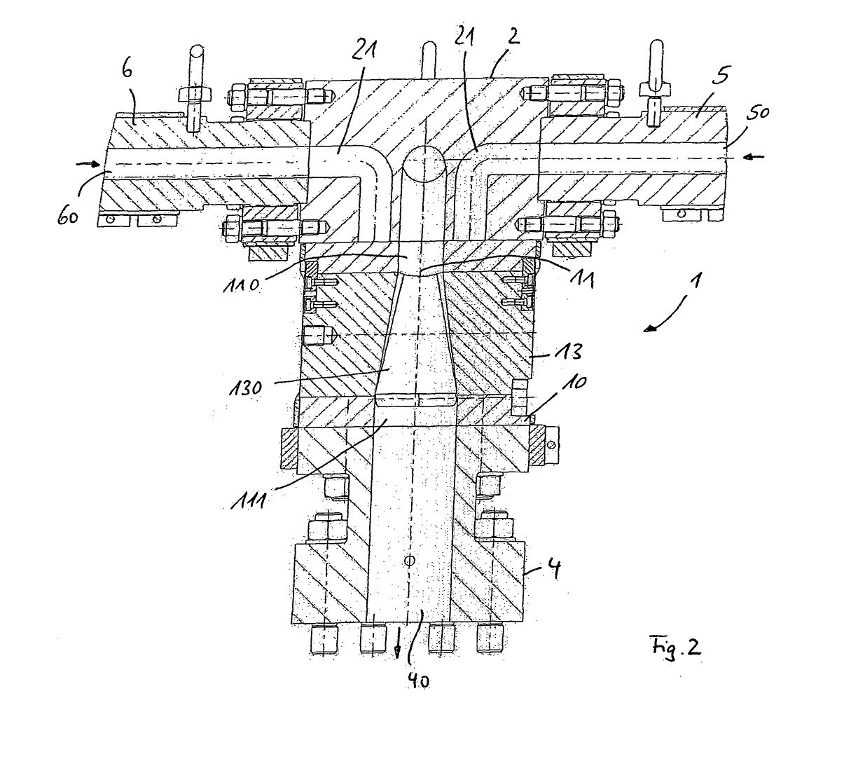

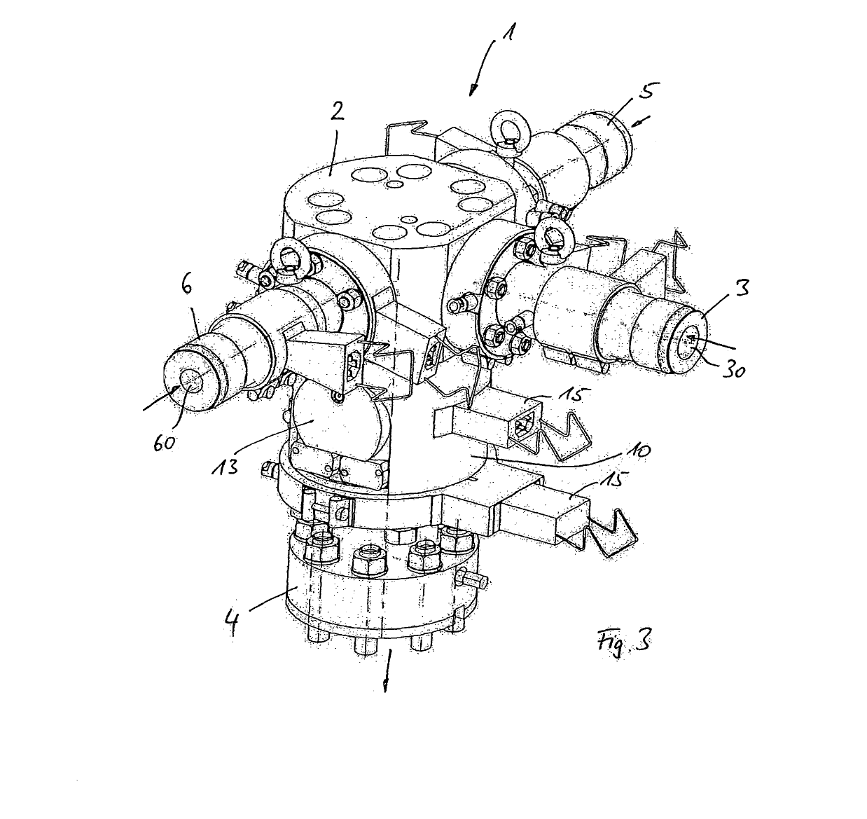

For major production conversions or adaptations, it is simple to remove a coextrusion pin 13, shown in FIGS. 1 and 2, from the housing 10 and replace it with another coextrusion pin 13 that has an adapted cross-sectional design in the region of the coextrusion pin 130 and/or of the outer surface 131, for which purpose the coextrusion pin 13 is easily accessible from the outside 1 of the coextrusion adapter, such as shown in FIG. 3.

Such coextrusion pins 13 are mechanically simple to produce and can be replaced in the coextrusion adapter 1 within a short conversion time.

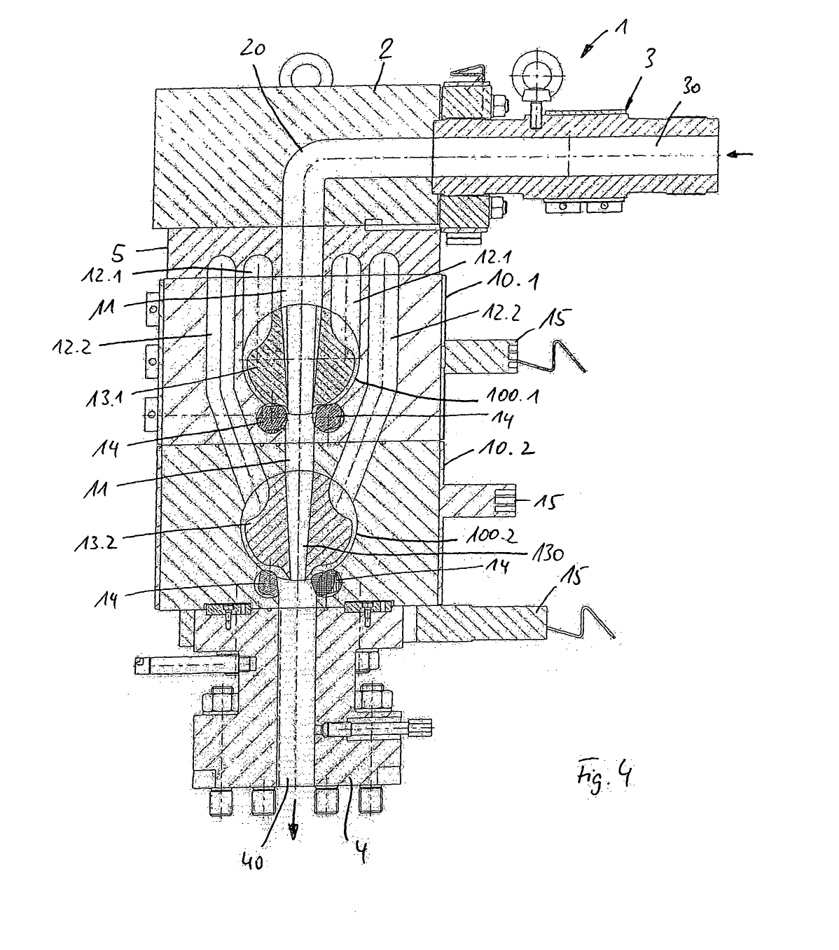

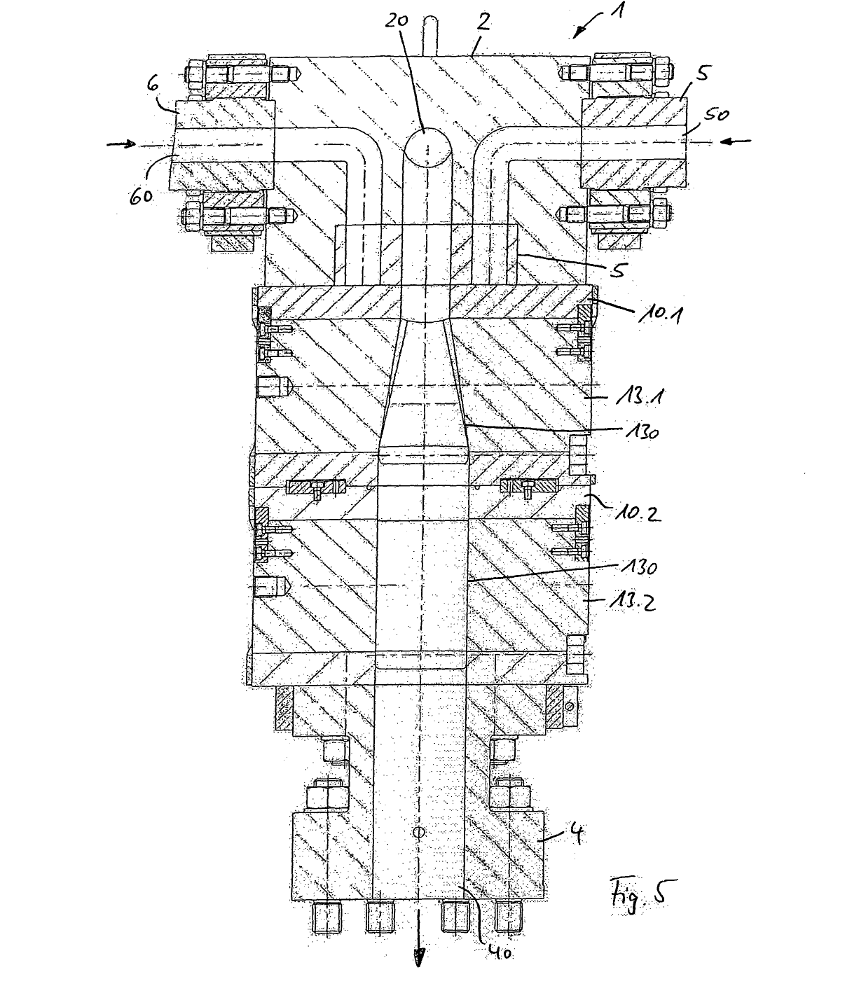

FIGS. 4-6 show an embodiment of the coextrusion adapter which is modified compared to the preceding exemplary embodiment of FIGS. 1-3 and which is distinguished by a larger number of layers to be processed.

Thus, a modular construction of the coextrusion adapter is used, which makes it possible to stack a plurality of the housings, already described, continuously on top of one another. In the exemplary embodiment shown in FIGS. 4-6, two housings 10.1, 10.2 are accordingly provided in succession to for the coextrusion adapter 1 between the angle connection piece 2 and the tool connection part 4, with the various central channels 11 continuing one another.

In each of the two housings 10.1 and 10.2, a receiving bore 100.1 and 100.2, respectively, is provided, into which a corresponding coextrusion pin 13.1, 13.2 as described above is inserted.

The first housing 10.1 as viewed in the flow direction also, besides the central channel 11 and the two coextrusion channels 12.1, has coextrusion channels 12.2 which are not yet discharged into the central channels 11 in the housing 101 but instead are continued in the downstream housing 10.2 and there, along the outer circumference of the inserted coextrusion pin 13.2, are applied as the outermost layers onto the layer sequence carried in the central channel 11. This course of the coextrusion channels 12.2 is the sole structural difference from the housing 10.2.

In this sense, what emerges from the outlet opening of the first housing 10.1 is an initially three-layer composite, formed of the inner layer brought via the melt channels 30, 20 and the two layers, applied to the outside, from the coextrusion channels 12.1 into the central channel 11 of the second housing 102 and which there is carried jointly through the channel bore 130 of the coextrusion pin 13.2. On the other hand, via the coextrusion channels 12.2, two further outer layers, then used as the outermost or cover layers, are applied to the three-layer pre-composite thus carried in the coextrusion channel 130.

With the embodiment of FIGS. 4-6 it is possible to produce a composite with a maximum of five layers.

It is understood that analogously to the double stacking of modular housings 10.1, 10.2 shown in FIGS. 4-6, it is also possible to use higher numbers of stacks of modular housings 10.1, 10.2 for attaining even greater numbers of layers, and at the least possible conversion expense.

Because of the short flow paths in the individual modular housings 10.1, 10.2, after a conversion, within the briefest possible time, as explained above, the desired layers and qualities are obtained, so that the proportion of rejects from production is minimized. This is also true for color changes and conversion.

1. A device for producing multi-layer composites of thermoplastic materials, including a coextrusion adapter (1) through which the thermoplastic materials can flow, the adapter having an inlet opening (110) and an outlet opening (111), in which adapter the thermoplastic materials are combined in layers, the device comprising the coextrusion adapter (1) having a modular construction comprising a plurality of housings (10.1, 10.2) stacked on one another in modular fashion, each housing having a central channel (11) disposed in the housing (10.1, 10.2) and at least one coextrusion channel (12) discharging into the respective central channel (11), the central channels (11) of the housings (10.1, 10.2) stacked on one another continuing one another, the central channel (11) and the thermoplastic materials flowable through the coextrusion channels (12) in a direction of the outlet opening (111), and each housing (10) having a receiving bore (100) penetrating the central channel (11) and into the receiving bore a coextrusion pin (13) insertable that has a channel bore (130) continuing the central channel (11) and in regions between an outer surface (131) and a wall of the receiving bore (100) forms forming a portion of, the at least one coextrusion channel (12).

2. The device according to claim 1, wherein the channel bore (130) in the coextrusion pin (13) and/or the portion of the at least one coextrusion channel (12), viewed in the direction of the outlet opening (111) has a cross section that varies from a circular design to a rectangular design.

3. The device according to claim 2, wherein one coextrusion channel (12) is embodied on each of two sides of the central channel (11) of a housing (10.1, 10.2).

4. The device according to claim 3, wherein the at least one coextrusion channel (12) has an adjusting device for the flow cross section.

5. The device according to claim 1, wherein the adjusting device is formed by a pin (14) that partly penetrates the coextrusion channel (12).

6. The device according to claim 5, wherein the pin (14) is mounted rotatably about a longitudinal axis in the housing (10.1, 10.2) and defines different flow cross sections as a function of a rotational position.

7. The device according to claim 6, wherein one coextrusion channel is the coextrusion channel (12) and can be closed completely by the pin (14).

8. The device according to claim 7, wherein a plurality of coextrusion pins (13) having a variably embodied geometry are provided in the region of the channel bore (130) and/or in the region of the outer surface (131) oriented toward the at least one coextrusion channel (12) and can be inserted selectively into the receiving bore (100) of the housings (10.1, 10.2).

9. The device according to claim 8, wherein in a region of the inlet openings (110, 120) of the central channel (11) and of the at least one coextrusion channel (12), an adapter plate (5) for connecting delivery devices (2, 3, 5, 6) for the thermoplastic materials is provided.

10. The device according to claim 1, wherein one coextrusion channel (12) is embodied on each of two sides of the central channel (11) of a housing (10.1, 10.2).

11. The device according to claim 1, wherein the at least one coextrusion channel (12) has an adjusting device for the flow cross section.

12. The device according to claim 5, wherein one coextrusion channel is the coextrusion channel (12) and can be closed completely by the pin (14).

13. The device according to claim 1, wherein a plurality of coextrusion pins (13) having a variably embodied geometry are provided in the region of the channel bore (130) and/or in the region of the outer surface (131) oriented toward the at least one coextrusion channel (12) and can be inserted selectively into the receiving bore (100) of the housings (10.1, 10.2).

14. The device according to claim 1, wherein in a region of the inlet openings (110, 120) of the central channel (11) and of the at least one coextrusion channel (12), an adapter plate (5) for connecting delivery devices (2, 3, 5, 6) for the thermoplastic materials is provided.
